(19) United States
(12) Patent Application Publication
(10) Pub. No.: US 2006/0225599 A1
(43) Pub. Date: Oct. 12, 2006

(54) Piece of ammunition or ammunition component comprising a structural energetic material

(75) Inventors: Luc Brunet, Bourges (FR); Muriel Regis, Bourges (FR)

Correspondence Address: STEPTOE & JOHNSON LLP, 1330 CONNECTICUT AVENUE, N.W., WASHINGTON, DC, 20036, US

(73) Assignee: GIAT INDUSTRIES, Versailles (FR)

(21) Appl. No.: 11/274,347

(22) Filed: Nov. 16, 2005

(30) Foreign Application Priority Data
Nov. 22, 2004 (FR) 04.12401

(51) Int. Cl. F42B 5/02; F42B 12/00

(52) U.S. Cl. 102/430; 102/473

(57) ABSTRACT

The invention relates to a piece of ammunition or ammunition component comprising a pyrotechnic load associated with a structure, such as a casing. This ammunition is characterized in that part at least of its structure is made of an energetic material comprising at least one energetic component mixed with at least a first structural reinforcement material.

### BACKGROUND OF THE INVENTION

1. Field of Invention

The technical scope of the present invention is that of ammunition or its components comprising a pyrotechnic load associated with a structure, such as a casing.

2. Description of the Related Art

Known pyrotechnic loads usually comprise one or several energetic materials, such as explosives or pyrotechnic compositions.

In known ammunition or components, the energetic materials are always put into place in casings, which, in addition to their function, for example splinter-generating (for explosive charges), ensure the mechanical strength of the energetic material. These casings reduce the mass of the pyrotechnic load able to be taken onboard the ammunition. They thereby constitute dead weight which prejudices carrying capacity, namely when the ammunition in question is a light aircraft such as an observation drone or attack drone. Moreover, they may constitute an impediment to the natural deterioration of the ammunition's residues in the environment.

Known ammunition or components usually comprise an energetic material designed to fulfill a single well determined function. Explosives thus ensure a destructive function. Pyrotechnic compositions (depending on their nature) ensure a masking, decoying or non-lethal function, such as noise, light, odor or colored-smoke generation.

To limit the equipment in ammunition, or to simplify the design of such ammunition, it may be desirable to make the onboard loads versatile, in order to enable different missions to be fulfilled by a single piece of ammunition.

### SUMMARY OF THE INVENTION

The aim of the invention is to propose a piece of ammunition or ammunition component that overcomes such drawbacks.

Thus, the ammunition or ammunition component according to the invention incorporates an energetic material having enough mechanical strength in itself to enable it to be used as a casing or structural element.

The mechanical properties and lightness of this energetic material may thus be calculated to make it possible for all or part of the body or structure of a piece of ammunition or air-borne craft such as a drone to be produced with it.

The piece of ammunition or ammunition component according to the invention may furthermore, depending on the variant, implement an energetic material having at least two operational regimes: an explosive regime and a combustive regime.

The piece of ammunition or ammunition component according to the invention may, without structural modification, fulfill at least two different missions: a destructive mission and a protective mission by masking, jamming, decoying or non-lethal dissuasion.

Thus, the invention relates to a piece of ammunition or ammunition component comprising a payload associated with a structure to carry the payload, ammunition or component wherein at least one part of the structure is made of an energetic material comprising at least one energetic component mixed with at least a first structural reinforcement material.

According to another characteristic, the piece of ammunition or ammunition component incorporates at least one priming device for the energetic structure, such device connected to control means.

The first structural reinforcement material may comprise at least one of the following materials: phenolic micro balloons, polystyrene balls, and carbon nanotubes.

According to one variant embodiment, the piece of ammunition or ammunition component may also incorporate a second structural reinforcement material selected from among long natural or synthetic fibers or materials made using such fibers.

The fibers may be selected from among the following materials: carbon, glass, hemp, and Kevlar fibers.

The piece of ammunition or ammunition component may thus globally comprise between 10 and 35% in mass of structural reinforcement material.

Advantageously, the piece of ammunition or ammunition component may comprise at least one masking or decoying material.

The masking or decoying material may be selected from among the following materials: short carbon fibers, carbon powder, brass powder, bronze powder, metallic flakes, polymer fibers coated with a conductive material, red phosphorus.

According to one embodiment, the piece of ammunition or ammunition component will incorporate at least one energetic component which is an explosive.

The energetic component may thus comprise at least one fusible explosive associated with one non-fusible explosive.

More particularly, the fusible explosive may have at least part of its structure made of an energetic material having the following composition in mass:
65 to 90% of an explosive composition associating one or several explosive materials and possible a binder,
10 to 30% of a first structural reinforcement material,
0 to 5% of a second structural reinforcement material in the form of long fibers.

More particularly, a piece of ammunition or ammunition component may be produced whose structure is at least partly made of an energetic material having the following composition in mass:
10 to 30% of a secondary fusible explosive,
10 to 30% of a first structural reinforcement material,
50 to 60% of a secondary non-fusible explosive,
0 to 5% of structural reinforcement fibers,
0 to 5% of

[symbol]

According [symbol] or ammunition component may be such that part at least of its structure will be made of an energetic material having the following composition in mass:
10 to 30% of a first structural reinforcement material,
50 to 60% of a secondary non-fusible explosive,
10 to 30% of a synthetic binder,
0 to 5% of structural reinforcement fibers,
0 to 5% of masking or decoying materials.

According to a particular embodiment of the invention a piece of ammunition or ammunition component may be made whose structure is at least partly made of an energetic material having the following composition in mass:
20% of trinitrotoluene,
50% of cyclonite,
10% of micro balloons,
20% of carbon or glass fibers.

According to another embodiment, a piece of ammunition or ammunition component may be made whose structure is at least partly made of an energetic material having the following composition in mass:
20% of trinitrotoluene,
50% of cyclonite,
10% of micro balloons,
10% of carbon or glass fibers,
10% of aluminum powder.

According to another embodiment, the piece of ammunition or ammunition component will be such that at least one of the energetic components will be constituted by a pyrotechnic composition.

The pyrotechnic composition may be a smoke-producing composition or a flare.

A piece of ammunition or ammunition component may thus more particularly be made whose structure is at least partly made of an energetic material having the following composition in mass:
75% of smoke-producing composition,
15% of a first structural reinforcement material.

A piece of ammunition or ammunition component may also be made whose structure is at least partly made of an energetic material having the following composition in mass:
75% of a light-producing composition,
15% of a first structural reinforcement material.

A piece of ammunition or ammunition component may also be produced whose structure is at least partly made of an energetic material having the following composition in mass:
50 to 60% of a pyrotechnic composition,
10 to 30% of a first structural reinforcement material,
15 to 25% of a brass powder or carbon fibers or aluminized glass.

According to one variant of the invention, the piece of ammunition or ammunition component may be such that the energetic material comprises at least one explosive component and at least one masking or decoying material and in this case the piece of ammunition or ammunition component will incorporate at least two priming devices for the energetic structure able to be ignited by control means, a first device designed to communicate a detonation regime to the structure thereby ensuring a destructive function for the piece of ammunition or ammunition component and a second device designed to communicate a combustive regime to the structure and thereby ensuring a masking or decoying function for the piece of ammunition or ammunition component.

According to a particular embodiment of the invention, the piece of ammunition constitutes an airborne craft such as a drone, the structure of energetic material forming the body and/or the wings of the drone and incorporating at least one housing to receive the motorization as well as the priming devices and control means.

The energetic material structure may also carry at least one payload such as a camera and/or data transmission relay.

According to one variant, the piece of ammunition may comprise a casing made of an energetic material and delimiting a cavity to receive and inert or pyrotechnic load.

The energetic material structure may be covered with a protective layer.

### BRIEF DESCRIPTION OF THE DRAWINGS

The invention will become more apparent from the following description of different embodiments, such description being made with reference to the appended drawings, in which:

FIG. 1 schematically shows a piece of ammunition according to a first embodiment of the invention,

FIG. 2 schematically shows a top view of a piece of ammunition according to a second embodiment of the invention, such ammunition being in the form of an airborne craft,

FIG. 3 schematically shows a side view of another embodiment of a piece of ammunition according to the invention,

FIG. 4 schematically shows a side view of another embodiment of a piece of ammunition according to the invention.

### DETAILED DESCRIPTION OF PREFERRED EMBODIMENTS

A piece of ammunition or ammunition component according to the invention is characterized in that part at least of its structure is made of an energetic material comprising at least one energetic component mixed with at least a first structural reinforcement material.

The structure in question may be the ammunition casing, casing delimiting a volume enclosing a classical explosive charge or else a pyrotechnic composition.

According to a preferred embodiment, the whole of the ammunition body constitutes a structure formed by a structural energetic material of sufficient mechanical strength.

One essential means of the invention is thus constituted by such a structural energetic material comprising at least one energetic component mixed with at least one structural reinforcement material.

Classically, by energetic material is meant a material able to supply chemical and/or mechanical energy in the form of a flame or detonation wave when ignited by a suitable priming component (squib or detonator).

An energetic component may thus have a detonating functioning regime or else simply a combustive functioning regime. A material having both modes of operation is certain to be obtained if such material has a combustive flame temperature greater than 2000 K and a detonation rate of more than 3000 m/s.

Energetic components mainly encompass explosives and pyrotechnic compositions.

Generally speaking, explosives are mixtures or pure substances whose functional decomposition regime is detonation (reaction propagation rate greater than 3000 m/s).

A pyrotechnic composition is a heterogeneous oxydo-reduction composition whose decomposition or combustion regime produces special effects: flame, light, noise, smoke, dispersion of non lethal substances, etc.

The purpose of energetic compositions is thus to ensure a given pyrotechnic function: wounding for explosives, masking, decoying or non lethal for pyrotechnic compositions.

The first structural reinforcement material implemented will preferably comprise a material enabling the block of energetic material to be made lighter without reducing its mechanical strength.

A first structural reinforcement material may be adopted that comprises at least one of the following materials: hollow spheres (such as phenolic micro balloons or polystyrene balls), short carbon fibers (length less than 10 mm), vegetal or synthetic fibers (aramide, for example), tubes (carbon nanotubes), or other pulverulent materials. The granulometry of the reinforcement material as well as the form selected will determine the quality of adherence of the charge to the binder as well as the mechanical properties. Someone skilled in the art will select the type of reinforcement material suited to the function of the type of energetic material used and the mechanical stresses to which the ammunition will be subjected.

Such materials are commercially available in different granulometries.

Micro balloons are namely used to manufacture pastes to seal inserts, and generally to make composite materials that are resistant to compression and shearing. They are frequently used to make structural parts in the aeronautic field.

It has been verified that with a proportion of such a material of between 10 and 35% in mass it is possible for a block of energetic material to be produced that conserves advantageous pyrotechnic capacities.

Thus, explosives have been obtained whose detonation rate goes from 3000 m/s (a lot of reinforcement) to 8000 m/s (little reinforcement).

Furthermore, the addition of reinforcements (such as carbon fibers) in pyrotechnic compositions increases the resistance of tablets without notably reducing the efficiency of the composition or its combustion rate.

The ammunition can thus be made up to 30% lighter which presents numerous advantages from an operational point of view.

For a classical piece of ammunition (projectile, missile, rocket, mine) it enables the transport and logistical implementation operations to be facilitated.

For a self-propelled projectile such as a rocket or missile, or else a drone, lightening of the explosive charge frees up mass for the integration of other elements of the projectile (homing device, booster, sub-munitions).

Depending on the applications envisaged, for example for mechanically highly stressed pieces of ammunition or ammunition components, it will be possible to complete the first structural reinforcement by a second reinforcement comprising long fibers in the form of free fibers or material (fiber length greater than 100 mm). Carbon, glass, hemp or Kevlar (trade mark) fibers or materials may thus be used. These fibers will be arranged according to the orientations of the mechanical stresses in the ammunition in question. It will also be possible to use structure of the honeycomb type.

The implementation techniques are those of the manufacture of composite materials: casting of a matrix onto a charge. The matrix is thus constituted by the energetic material and the charge is constituted by the reinforcement fibers.

The energetic materials implemented may comprise at least one explosive.

This explosive will advantageously be a fusible explosive such as TNT or TNMA (trinitromethylaniline) which may be associated with a non fusible explosive (such as homocyclonite or cyclonite).

Most explosive materials have two possible stable modes of functioning (combustion and detonation) which depend on the ignition mode implemented and namely on the energy level communicated by the ignition means.

By implementing a detonator it is possible to communicate a detonating regime (reaction propagation rate greater than 3000 m/s) to be communicated to the explosive.

By implementing a squib a combustion regime (reaction rate less than 1000 m/s) may be communicated to the explosive.

At least one masking or decoying material may be incorporated into the energetic material.

Thus, a masking or decoying function may be obtained with the material when it is ignited using a combustion regime.

By way of a masking material, short carbon fibers (length less than 8 mm) may be selected, as may carbon powder, metallic powders (brass or bronze), metal oxide powders (TiO2, SiO2). The granulometry of these powders will be selected such that the median diameter is between 10 and 20 μm or close to the incident radiation wavelength to be masked.

By way of a decoying material, conductive particles or fibers less than one centimeter in length may be used (glass or polymer fibers coated with a conductive metal, carbon nanotubes).

Granules or pellets of a phosphorus-based pyrotechnic composition may also be incorporated whose combustion by dispersion will enable the saturation of a zone by the dispersion of hot points distributed over a wide area.

When the energetic material is made to detonate or combust, the masking or decoying material will be dispersed (and may be ignited), thereby ensuring the desired function.

A piece of ammunition may thus be made comprising a structural energetic material with the following composition in mass:
65 to 90% of an explosive composition associating one or several explosive materials and possibly a binder,
10 to 30% of a first structural reinforcement material,
0 to 5% of a second reinforcement material in the form of long fibers.

A piece of ammunition may namely be produced comprising a structural energetic material having the following composition in mass:
10 to 30% of a fusible secondary explosive,
10 to 30% of micro balloons (phenolic or polyurethane),
50 to 60% of non fusible secondary explosive,
0 to 5% of structural reinforcement fibers,
0 to 5% of masking or decoying material.

Such an energetic material is implemented by casting.

A piece of ammunition may also be produced comprising a structural energetic material having the following composition in mass:
10 to 30% of polystyrene balls,
50 to 60% of non fusible secondary explosive,
10 to 30% of synthetic binder,
0 to 5% of structural reinforcement fibers,
0 to 5% of masking or decoying material.

The latter energetic materials are implemented by compression or by curing in a suitable mould (composite explosives).

By way of example, the following energetic materials have been made:

### EXAMPLE 1

20% of Trinitrotoluene,
10% of micro balloons (phenolic or polyurethane),
50% of cyclonite,
20% of carbon fibers.

### EXAMPLE 2

20% of Trinitrotoluene,
10% of micro balloons (phenolic or polyurethane),
50% of cyclonite,
10% of carbon fibers,
10% of aluminum powder.

The aluminum powder may have a micrometric granulometry (around 100 micrometers). It improves the blast effect of the composition.

These two materials have two functioning regimes: a combustion regime and a detonating regime.

The table below gives the computed detonation rates for each material.

| Example | Detonation rate (m/s) |
|---|---|
| Example 1 | 6984 m/s |
| Example 2 | 7400 m/s |

These values are analogous to those for a classical explosive such as hexolit 65/35 (65% in mass of trinitrotoluene, 35% of cyclonite) whose detonation rate is 8000 m/s.

The material according to example 1 moreover burns at 2192 K dispersing carbon (almost 17% in mass of carbon particles generated). When ignited in the combustion mode, it may thus ensure a masking function.

It is possible for carbon fibers to be replaced by other reinforcement materials, for example by aluminized glass fibers. These fibers will be dispersed when the composition combusts, thereby ensuring a decoying function. The composition may also be ignited in the detonation made.

A composition may thus be produced which associates:

### EXAMPLE 3

20% of Trinitrotoluene,
10% of micro balloons (phenolic or polyurethane),
50% of cyclonite,
20% of aluminized glass fibers.

A piece of ammunition may also be made comprising a structural energetic material in which at least one of the energetic components is constituted by a non explosive pyrotechnic composition, for example an oxydo-reduction composition.

This pyrotechnic composition may be a smoke-producing, light-producing, dazzling, color or odor producing composition or may perform another effect (for example, a gas generating composition enabling the dispersion of tear gas substances).

The material according to the invention, made lighter by the structural reinforcement, enables ammunition to be produced of lesser mass but which has sufficient mechanical strength.

A smoke-producing composition such as described by patents FR2560186 and FR2583037, or a composition incorporating red phosphorus (smoke-producing or decoying function) may thus be used.

A piece of ammunition may thus be produced incorporating a structural energetic mass having the following composition in mass:
50 to 80% of a pyrotechnic composition,
10 to 30% of a first structural reinforcement material,
0 to 5% of long structural reinforcement fibers.

The first structural reinforcement material will be a material of the micro ball or micro balloon type and will thus enable the energetic material to be made lighter.

The long fibers of the second reinforcement material may improve the mechanical strength of the energetic material produced.

By way of pyrotechnic composition, a smoke-producing composition may be implemented such as one of those described by patent FR2583037 and associating a metallic powder (such as magnesium), a carbon particle generating binder (such as chlorinated naphthalene) and a fluorinated binder (such as vinylidene polyfluoride).

By way of pyrotechnic composition, a light-producing composition may be chosen, for example associating a metallic powder (such as magnesium) and a fluorinated binder (such as polytetrafluorethylene, better known by its trade mark, Teflon).

The following compositions may thus be produced:

### EXAMPLE 4

15% of polystyrene balls,
75% of smoke-producing composition.

The smoke-producing composition may associate in mass: 17% of magnesium, 70% of chlorinated naphthalene, 13% of fluorinated binder.

### EXAMPLE 5

15% of polystyrene balls,
75% of light-producing composition.

The light-producing composition may associate in mass: 54% of magnesium, 30% of polytetrafluorethylene and 16% of chlorofluoroethylene copolymer (better known under its trade mark Viton).

A structural energetic material may also be made in which brass powder, carbon fiber or chaffs will be incorporated into an oxydo-reduction or gas-generating pyrotechnic composition.

Such an arrangement enables masking or decoying material (brass powder or fibers) to be dispersed when the composition is ignited.

A composition may be made, for example, associating:
50 to 65% of pyrotechnic composition,
10 to 30% of a first structural reinforcement material,
15 to 25% of brass powder or carbon fibers or aluminized glass fibers.

The first structural reinforcement material will be a material of the micro ball or micro balloon type and will thus enable the material to be made lighter.

The pyrotechnic composition will be, for example, a composition associating (proportions in mass): aluminum (20%) and copper oxide (80%) or aluminum (40%) and potassium perchlorate (60%).

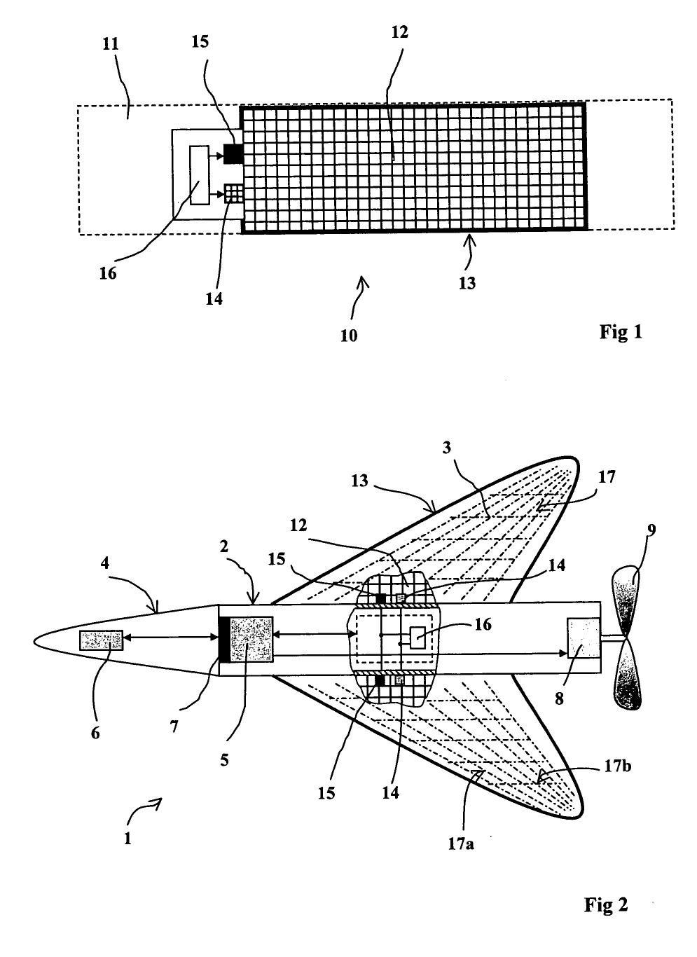

By way of example of implementation, FIG. 1 shows a piece of ammunition 10 according to one embodiment of the invention, such ammunition comprising a casing 11 of which only the outline is shown in dotted lines.

This casing encloses a structure or block 12 of a structural energetic material such as described previously. The block 12 is placed in a casing 13 which improves its mechanical strength and imperviousness. The casing 13 is, for example, constituted by a layer of cellulosic varnish or else by a film of plastic material, for example polyethylene film, a heat-shrinkable material, an aluminized film or material impregnated with a binder.

The ammunition 10 also comprises two different priming devices 14 and 15 connected to control means 16 (for example, a programmable electronic fuse).

The structural energetic material of the block 12 here comprises at least one explosive component and at least one masking or decoying material, such as short carbon fibers, decoying flakes (chaffs), a brass powder or red phosphorus.

The first priming device 15 is designed to communicate a detonation regime to the block 12. This device is constituted, for example, by a hot or exploded wire detonator or else by an exploding foil initiator (more commonly known as a Slapper).

The second priming device 14 is designed to communicate a combustion regime to the block 12. This device is a squib, that is to say a component producing a flame. A micro plasma torch (such as that described by patent FR2768810) may also be used.

Thus, according to operational requirements the ammunition can be made to function in a destructive mode (by activating the detonation of the block 12) or in a masking mode (by activating the combustion of the block 12).

The invention thus enables a lighter piece of ammunition to be produced that has two separate modes of functioning.

It is naturally possible for a lighter piece of ammunition to be defined that implements a material having a single mode of functioning, for example smoke-producing or explosive.

FIG. 2 shows another embodiment of the invention in which the ammunition is an airborne craft 1 or drone.

This craft comprises a body (or fuselage) 2 having two wings 3. The fuselage is extended by a nose cone 4.

The fuselage encloses an electronic control unit 5 connected to a sensor 6 positioned in the nose cone 4. The sensor 6 may incorporate a data transmission sensor camera and also at least one infrared sensor or a radiometer. Transmission means 7 are incorporated into the electronic control unit 5 enabling communications (emission/reception) with a distant steering post (not shown), placed, for example, in a vehicle.

The electronic control unit 5 is also connected to a motor 8 which drives a propulsive unit 9, such as a propeller.

Each of the drone's 1 wings 3 is made of a block 12 of structural energetic material. Long fibers 17 (carbon or glass) are incorporated into the blocks 12 to mechanically reinforce them. As shown schematically in FIG. 2, the fibers 17a thus form a network associating fibers 17a parallel with the wing's leading and trailing edge and fibers 17b perpendicular to the previous ones. Each block 12 will be covered on the outside by an external casing 13, for example, a film of plastic material or a conductive varnish.

Each block 12 may be ignited by two different primers, a squib 14 and a detonator 15. These devices are connected to 35 control means 16 which are in turn connected to the electronic control unit 5.

Thus, the drone 1 carries a payload formed of the camera 6 and the data transmission means 7.

This drone may thus fulfill an observation role like a conventional drone.

The structural energetic material forming its wings 3 also enables the drone 1 to be used as attack ammunition.

In this case, the two wings are ignited by the control means 16 and by means of the detonators 15.

The observation 6 and transmission 7 means enable the drone to be guided towards its target. The electronic control means may then be activated at a distance thanks to a command received by the transmission means 7. The command will be emitted, for example, by a firing platform such as a vehicle that additionally ensures the steering of the drone.

Alternatively, the control means for the detonators 15 may be implemented autonomously by the control unit 5 further to the detection by the observation means 6 of a target having given characteristics (given dimension and/or infrared signature).

To fulfill the masking or decoying function (according to the nature of the material associated with the active material) it will, lastly, be possible to activate the ignition of the wings 3 in a combustion mode. This mode will be initiated by the ignition of the squibs 14. Such ignition may, once again, be controlled at a distance by an operator or may occur automatically after a pre-programmed lapse of time memorized in the electronic control unit 5.

It is thus possible to make a drone of reduced mass, for example less than 500 g, which nevertheless carries on-board motorization and observation means.

This drone will ensure the observation functions of a conventional drone.

It will also fulfill the pyrotechnic functions (detonation or masking or decoying), which will be ensured by all of part of the drone's structure without prejudicing its carrying capacities.

The provision in ammunition of combat vehicles will thus be considerably simplified whilst supplying low-cost observation, attack and defense means able to fulfill the functions of other, previously separate, means (observation drone, retaliation ammunition, masking or decoying ammunition).

By way of a variant, it is also possible to make a drone whose body 2 is in the form of a tube made of a structural energetic material such as that described previously. This tube may be ignited by specific priming means or else by one or several pyrotechnic relays positioned between the wings and the body.

The drone body may also be made of a material of a different nature to that of the wings, for example to ensure another function (decoying, for example, if the wings ensure a masking function).

By way of a variant, it is naturally possible for a drone to be defined whose wings are made of a material that only fulfils one function: detonation, masking or decoying. In this case, each block will only incorporate a single priming device (squib or detonator) connected to the control means.

According to the invention, other types of ammunition may be made in the form of airborne craft.

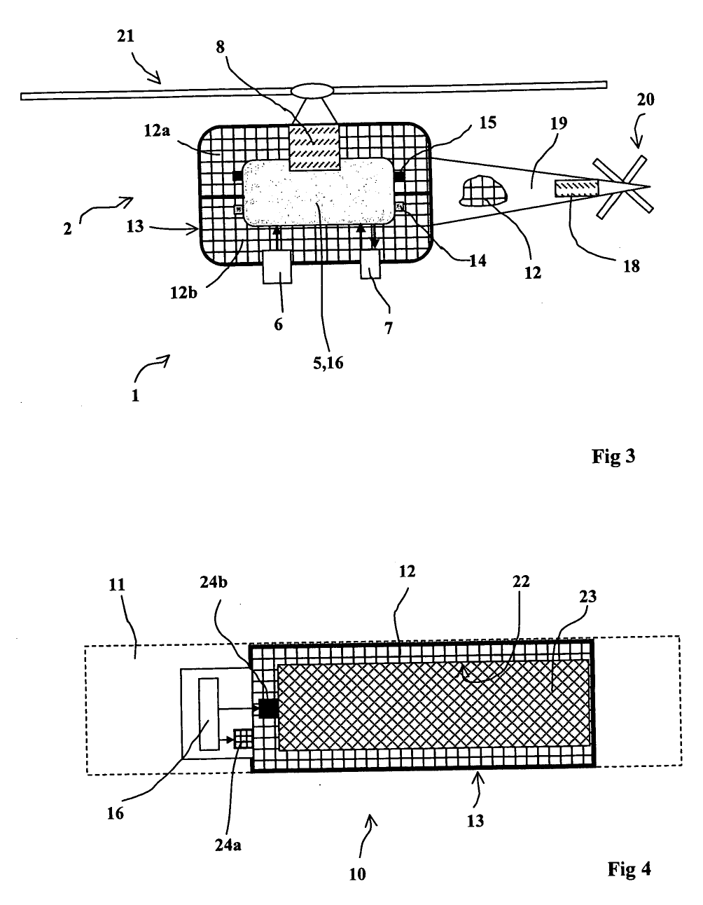

FIG. 3 thus shows a small helicopter 1 whose body 2 is formed by assembling two shells 12a and 12b of a structural energetic material such as described previously. This material is enclosed by a casing 13 of a plastic material. The body 2 has a tail 19 which will also advantageously be made of a structural energetic material 12, of the same or a different nature to that of the body.

The tail 19 encloses a small trimming motor 18 which activates a rear rotor 20. The body 2 encloses a main motor 8 which drives a lifting rotor 21.

The body 2 incorporates an inner housing inside which the electronic control unit 5 is placed as well as the control means 16 for the priming devices 14 and 15 (squibs and/or detonators).

An observation camera 6 is connected to the control unit and transmission means 7 such as an antenna connected to a modulator/demodulator will also be connected to the control unit 5.

Such a drone operates similarly to that described previously. Since the structure of the body 2 is not particularly mechanically stressed, the long fiber reinforcements are unnecessary. They may, however, be provided to reinforce the tail 19 is this is (also) made of a structural energetic material.

It is naturally possible for the tail to be made of a plastic material, an aluminum alloy or of a biodegradable material.

Other embodiments of the invention are possible.

Thus, it is possible according to the invention to make a piece of ammunition that associates a casing made of an energetic material which delimits a cavity receiving a classical pyrotechnic composition (explosive or pyrotechnic) or a scatterable inert charge.

FIG. 4 shows a piece of ammunition made according to this variant.

The carrying structure 12 is here constituted by a casing which delimits a cavity 22 inside which a classical load 23 (explosive or pyrotechnic) is placed. The ignition means comprise a first igniter 24a ensuring the ignition of the structural casing 12 and a second igniter 24b enabling the load 23 to be ignited.

Depending on operational requirements, the casing 12 will be ignited alone or else the load 23 inside the casing will be ignited. By way of a load, it is thus possible to have a classical explosive charge (for example associating cyclonite and trinitrotoluene) inside an energetic casing enclosing masking fibers or a decoying material.

If the casing is ignited, a masking or decoying function is obtained, the explosive load being burned by the energy delivered by the casing.

If the on-board load itself is ignited in the detonation mode, a destructive effect is obtained.

It will naturally be possible for the load 23 to be replaced by a masking or decoying payload (carbon fibers, brass powder, reflective flakes). Igniting the casing structure 12 will thus ensure the dispersion of the payload.

In accordance with the invention, an ammunition component, for example a squib or else a detonator, may be made using an energetic material comprising at least one energetic component mixed with at least one structural reinforcement.

The invention thus enables the metallic casings which generally enclose the igniting compositions to be eliminated. A classical ignition composition may be put in place in a cup made of a structural energetic material, or an ignition composition incorporating a structural reinforcement material may be made.

Igniter tubes may thus be made for artillery munitions or for shaped charge explosive warheads.

What is claimed is:

1. A piece of ammunition or ammunition component comprising a payload associated with a structure to carry the payload, wherein at least one part of said structure is made of an energetic material comprising at least one energetic component mixed with at least a first structural reinforcement material.

2. A piece of ammunition or ammunition component according to claim 1, wherein said piece incorporates at least one priming device for the energetic material, said device being connected to control means.

3. A piece of ammunition or ammunition component according to claim 2, wherein said first structural reinforcement material comprises at least one of the following materials: phenolic micro balloons, polystyrene balls, carbon nanotubes.

4. A piece of ammunition or ammunition component according to claim 3, wherein said piece also incorporates a second structural reinforcement material selected from among long natural or synthetic fibers or materials made using such fibers.

5. A piece of ammunition or ammunition component according to claim 4, wherein said fibers are selected from among the following materials: carbon, glass, hemp, Kevlar fibers.

6. A piece of ammunition or ammunition component according to claim 1, wherein said piece globally comprises between 10 and 35% in mass of said first structural reinforcement material.

7. A piece of ammunition or ammunition component according to claim 4, wherein said piece globally comprises between 10 and 35% in mass of said second structural reinforcement material.

8. A piece of ammunition or ammunition component according to claim 1, wherein said piece comprises at least one masking or decoying material.

9. A piece of ammunition or ammunition component according to claim 5, wherein said masking or decoying material is selected from among the following materials: short carbon fibers, carbon powder, brass powder, bronze powder, metallic flakes, polymer fibers coated with a conductive material, red phosphorus.

10. A piece of ammunition or ammunition component according to claim 1, wherein said at least one of the energetic components is an explosive.

11. A piece of ammunition or ammunition component according to claim 10, wherein said energetic component comprises at least one fusible explosive associated with one non-fusible explosive.

12. A piece of ammunition or ammunition component according to claim 11, wherein said structure is at least partly made of an energetic material having the following composition in mass:
65 to 90% of an explosive composition associating one or several explosive materials and possible a binder,
10 to 30% of a first structural reinforcement material,
0 to 5% of a second structural reinforcement material in the form of long fibers.

13. A piece of ammunition or ammunition component according to claim 11, wherein said structure is at least partly made of an energetic material having the following composition in mass:
10 to 30% of a secondary fusible explosive,
10 to 30% of a first structural reinforcement material,
50 to 60% of a secondary non-fusible explosive,
0 to 5% of structural reinforcement fibers,
0 to 5% of masking or decoying materials.

14. A piece of ammunition or ammunition component according to claim 11, wherein said structure is at least partly made of an energetic material having the following composition in mass:
10 to 30% of a first structural reinforcement material,
50 to 60% of a secondary non-fusible explosive,
10 to 30% of a synthetic binder,
0 to 5% of structural reinforcement fibers,
0 to 5% of masking or decoying materials.

15. A piece of ammunition or ammunition component according to claim 13, wherein said structure is at least partly made of an energetic material having the following composition in mass:
20% of trinitrotoluene,
50% of cyclonite,
10% of micro balloons,
20% of carbon or glass fibers.

16. A piece of ammunition or ammunition component according to claim 13, wherein said structure is at least partly made of an energetic material having the following composition in mass:
20% of trinitrotoluene,
50% of cyclonite,
10% of micro balloons,
10% of carbon or glass fibers,
10% of aluminum powder.

17. A piece of ammunition or ammunition component according to claim 1, wherein said at least one of energetic components is constituted by a pyrotechnic composition.

18. A piece of ammunition or ammunition component according to claim 17, wherein said pyrotechnic composition is a smoke-producing composition or a flare.

19. A piece of ammunition or ammunition component according to claim 18, wherein said structure is at least partly made of an energetic material having the following composition in mass:
75% of smoke-producing composition,
15% of a first structural reinforcement material.

20. A piece of ammunition or ammunition component according to claim 18, wherein said structure is at least partly made of an energetic material having the following composition in mass:
75% of a light-producing composition,
15% of a first structural reinforcement material.

21. A piece of ammunition or ammunition component according to claim 17, wherein said structure is at least partly made of an energetic material having the following composition in mass:
50 to 60% of a pyrotechnic composition,
10 to 30% of a first structural reinforcement material,
15 to 25% of a brass powder or carbon fibers or aluminized glass.

22. A piece of ammunition or ammunition component according to claim 2, wherein said energetic material comprises at least one explosive component and at least one masking or decoying material and in that said piece of ammunition or ammunition component will incorporate at least two priming devices for said energetic structure able to be ignited by control means, a first device designed to communicate a detonation regime to said structure thereby ensuring a destructive function for said piece of ammunition or ammunition component and a second device designed to communicate a combustive regime to said structure and thereby ensuring a masking or decoying function for said piece of ammunition or said ammunition component.

23. A piece of ammunition or ammunition component according to claim 1, wherein said piece constitutes an airborne craft such as a drone, said structure of energetic material forming the body and/or the wings of said drone and incorporating at least one housing to receive a motorization as well as a priming devices and control means.

24. A piece of ammunition or ammunition component according to claim 22, wherein said energetic material structure also carries at least one payload such as a camera and/or data transmission relay.

25. A piece of ammunition or ammunition component according to claim 1, wherein said piece comprises a casing made of an energetic material and delimiting a cavity to receive and inert or pyrotechnic load.

26. A piece of ammunition or ammunition component according to claim 1, wherein said energetic material structure is covered with a protective layer.
